(19) United States
(12) Patent Application Publication
(10) Pub. No.: US 2025/0260709 A1
(43) Pub. Date: Aug. 14, 2025

(54) SOFTWARE TOOL AND METHOD FOR ANALYSIS OF CYBERSECURITY VULNERABILITIES

(71) Applicant: Siemens Corporation, Washington, DC (US)

(72) Inventors: Bruno Paes Leao, Skillman, NJ (US); Daniel Grinkevich, Westfield, NJ (US); Jagannadh Vempati, Monroe Township, NJ (US); Patrick Mostyn, Nazareth, PA (US); Siddharth Bhela, Princeton Junction, NJ (US); Tobias Ahlgrim, Philadelphia, PA (US)

(73) Assignee: Siemens Corporation, Washington, DC (US)

(21) Appl. No.: 18/867,030

(22) PCT Filed: Jun. 20, 2023
(86) PCT No.: PCT/US2023/025721

§ 371 Date: Nov. 19, 2024

Related U.S. Application Data
(60) Provisional application No. 63/353,796, filed on Jun. 20, 2022.

(51) Int. Cl. H04L 9/40; H04L 41/16

(52) U.S. Cl. CPC H04L 63/1433; H04L 41/16

(57) ABSTRACT

A system and method for analysis of potential cybersecurity threats in an engineered system combines a functional simulation of the system with a cyberattack information layer. The cyberattack information layer informs the simulation with respect to the effects of a potential cyberattack on devices and links in the system. An iterative AI-based sequential decision-making optimization identifies a sequence of attacker steps for carrying out a cyberattack which has the greatest impact on a key performance indicator relating to operation of the system. The cyberattack information layer includes information relating to a topology and devices in the system from a computer network perspective and includes information on an amount of effort required to carry out possible attacks affecting each device or communication link in the system. The decision-making optimization may be run iteratively between the simulation and the cyberattack information layer to find a most impactful sequence of attacker actions.

### TECHNICAL FIELD

This application relates to cybersecurity. Specifically, this application relates to analysis of cybersecurity vulnerabilities in engineered systems.

### BACKGROUND

Many tools and methods exist for cybersecurity analysis of engineered systems. However, one important characteristic of all such tools and methods is that they consider the system exclusively from the perspective of the computer network, with no direct integration with the system functional/operational behavior of an Operational Technology (OT) system. This omission is significant in that an adversarial attack typically targets a disruption of OT system operations.

### SUMMARY

This disclosure provides a software tool which can identify the most critical cybersecurity vulnerabilities associated with engineered systems. It is especially applicable for analysis of scenarios where the goal of the adversary is to disrupt the operation of such systems. The tool integrates a layer of cybersecurity-related information into existing simulation models representing the operation/functionality of the system of interest. Computer network devices and connections represented in the invention can be associated to the corresponding components in the simulation and their behavior following cyberattacks. A key aspect of the tool is the application of tree search methods for sequential decision-making optimization yielding the most impactfull attack vectors affecting the key performance indicators (KPIs) of interest for a defined attacker profile.

A system and method for analysis of cybersecurity vulnerabilities in an engineered system combines a functional simulation of the system with a cyberattack information layer. The cyberattack information layer informs the simulation with respect to the effects of a potential cyberattack on devices and links in the system. An iterative AI-based sequential decision-making optimization identifies a sequence of attacker steps for carrying out a cyberattack which has the greatest impact on a key performance indicator relating to operation of the system. The cyberattack information layer includes information relating to a topology and devices in the system from a computer network perspective and includes information on an amount of effort required to carry out possible attacks affecting each device or communication link in the system. The decision-making optimization may be run iteratively between the simulation and the cyberattack information layer to find a most impactful sequence of attacker actions.

### BRIEF DESCRIPTION OF THE DRAWINGS

The foregoing and other aspects of the present invention are best understood from the following detailed description when read in connection with the accompanying drawings. For the purpose of illustrating the invention, there is shown in the drawings embodiments that are presently preferred, it being understood, however, that the invention is not limited to the specific instrumentalities disclosed. Included in the drawings are the following Figures:

### DETAILED DESCRIPTION

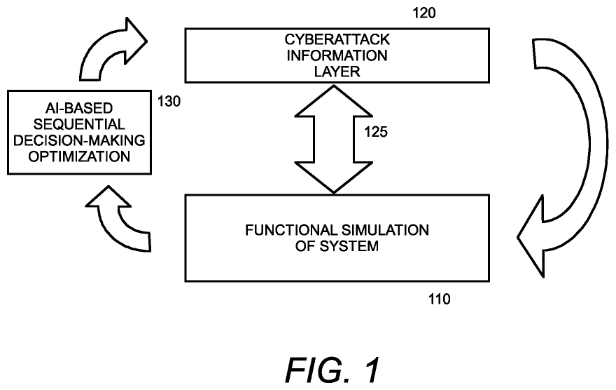

FIG. 1 is an illustration of an architecture for analysis of cybersecurity vulnerabilities according to aspects of an embodiment of this disclosure. A functional simulation/Digital Twin of the engineered system 110 under analysis may be created based on standard engineering tools or programming languages, such as Matlab/Simulink or Python. Being a standard functional simulation of the system, the simulation model can usually be obtained from previous developments associated to other types of analyses.

A cyberattack information layer 120 contains information relating to the topology and devices associated with the system from a computer network perspective. This may include information with respect to possible attacks that may be performed to affect each device or communication link. Information 125 is exchanged between the cyberattack information layer 120 and the functional simulation model 110 Additionally information relating to corresponding measures of associated effort required for implementation of each attack.

An sequential decision-making optimization framework 130 runs iteratively between the functional model 110 and the cyberattack information layer 120 to produce a sequence of attacker steps which serves to generate the most disruption to system operations. Disruption may be measured and optimized based on configurable KPIs associated with system operation. The may be implemented using an artficial intelligence (AI) based technique or other optimization techniques may be used.

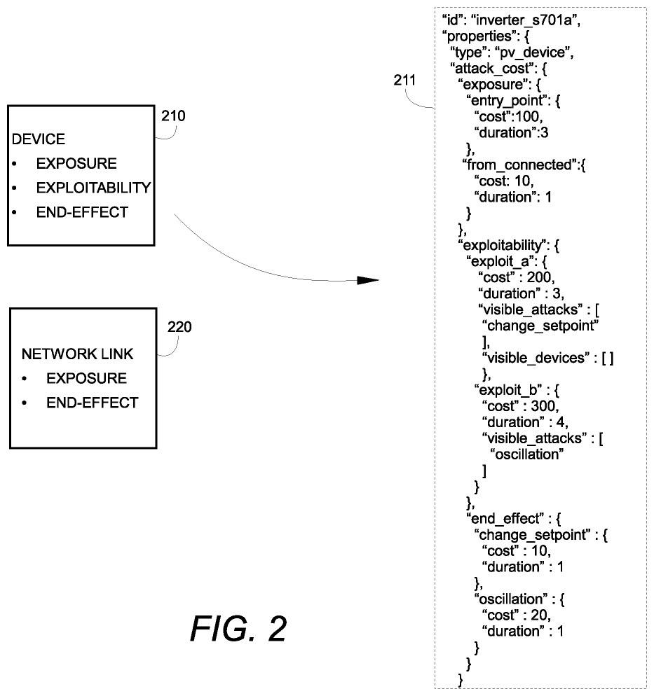

The cyberattack information layer 120 contains information about the system topology. According to an embodiment, this topology information is encoded using NetJSON format and includes a list of computer network devices in the system and their corresponding interconnections. Once the system simulation 110 and the cyberattack information 120 are available, the optimization 130 can be employed to obtain the most impactful attack paths. Methods based on Monte Carlo Tree Search (MCTS) may be employed for this purpose. The optimization goal is defined based on system KPIs which can be evaluated using the simulation model. For each device and network link, information regarding possible attacker actions are also included. This information is structured in layers as described with reference to FIG. 2:

For devices, information relating to each device: the following layers are provided, Exposure—refers to initial access to the device (e.g., telnet through an open port). The next layer is Exploitability or the ability to get access to the internals of the device (e.g., privilege escalation) in order to enable the final layer of end-effects or gaining access to other parts of the network. The final layer for devices is End-Effect. End effects have to do with Implementing adversary actions that impact system operation, including but not limited to changing operating mode of equipment.

For network links, the two layers include Exposure: Getting access to the network link, for example port mirroring. The second layer is End-Effect, which like the device end effect, represents the implementation adversary actions that impact system operations. For example, an end effect of a network link may include false data injection, among other actions.

Referring to FIG. 2, a layered device description may be described using a NetJSON format 211. Network links may be implemented in the same way and are not shown in FIG. 2 for brevity.

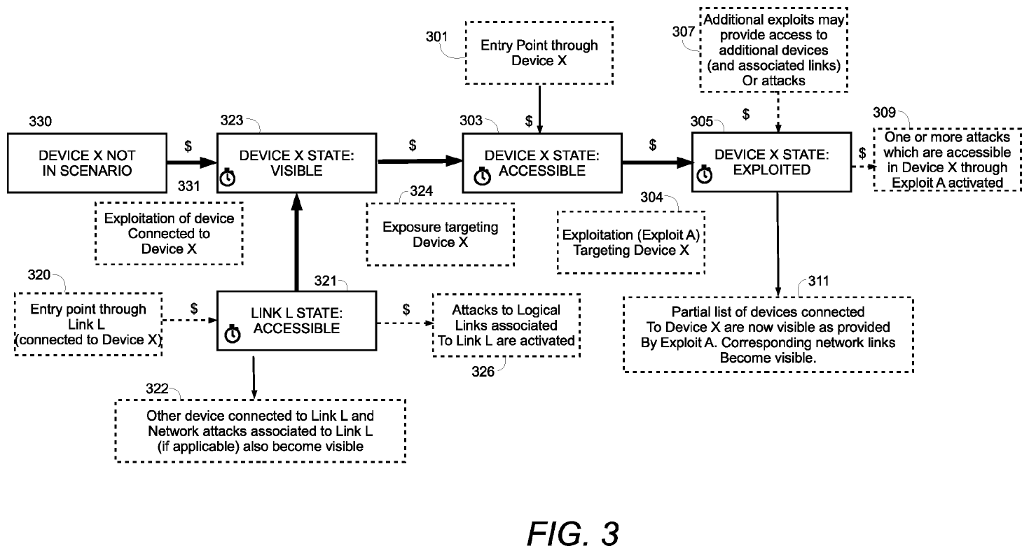

An attack scenario can be defined as a sequence of adversary action. The software tool keeps track of states for each device and network link and their transitions following each adversary action. FIG. 3 illustrates state transitions relating to a specific device or network link. Each possible action is also related to the associated effort involved in performing that action. Referring to FIG. 3 this is encoded as cost and duration. Here, “cost” refers to an abstract measure of effort which has only relative meaning when comparing possible attacker actions with each other. In this example, information about a device is represented in NetJSON format, including Exposure, Exploitability and End-Effect layers.

Different attacker profiles may be considered, for instance, by defining an attacker budget representing an upper limit to the total effort the attacker can perform during the overall attack. Further, attacker profiles may account for a potential attacker's skill level, such as an unskilled hacker or “Script Kiddie”, a skilled hacker, a security researcher or penetration tester, a malicious user either normal or priveleged, or a state sponsored attack or malicious corporation.

Referring again to FIG. 3 a device X may include an entry point 301 to the system passing through device X. If the state of device X is Accessible 303, the the action of exploitation targeting device X 304 may occur. This will update the state of device X to Exploited 305. Once device X is exploited, it may lead to the possiblility of other exploits that may gain access to other devices 307. Other attacks that are accessible through Exploit A due to the exploitation of device X may also be activated 309. The execution of exploit A may cause a partial list of devices connected to device X to become visible 311.

Similarly, there may be a scenario where device X is not involved in a given scenario 330. The exploitation of another device that is connected to device X 331 may cause device X to become visible 323 bringing device X into focus for a potential attack. In similar manner, a network link L may be in an Accessible state 321, which allows an entry point through link L. Link L, for purposes of this discussion may be connected to device X 320. Via link L, access may be made to cause device X to become visible 323. Additionally, attacks may be launched against other devices which are logically connected via link L 326. Further, other devices connected to link L, or attacks associated with link L may also become visible 322. Actions denoted with a dollar sign, indicate a portion of an attackers budget must be used to perform the action. The changes in state of some devices and links may be denoted by clock representing a time factor that must be considered as part of an overall attack.

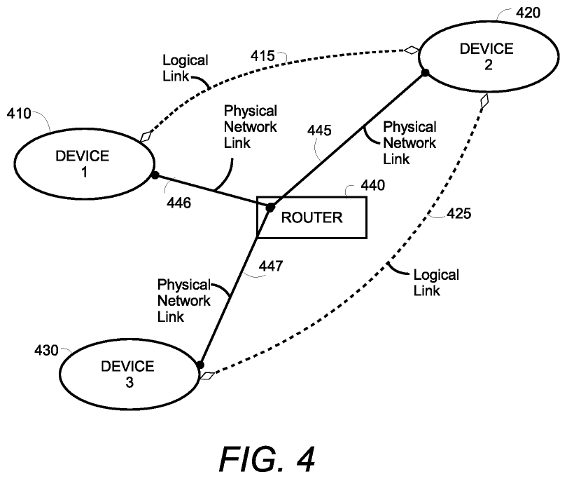

FIG. 4 illustrates an example of another relevant aspect to consider about attacker actions targeting the network communication, which is the distinction between network (physical) link and logical link. Network links are the entities represented in the model constituting the network topology. Logical links as defined here represent the pairs of devices which are the generators or consumers of the communication information. A router 440 distributes communication among Device 1 410, Device 2 420 and Device 3 430. Network links, such as the connection between Device 2 and the router 445 are indicated by the solid line segments in the diagram 445, 446, 447. However, since the router 440 is not a generator or consumer of the information, the router 440 is disregarded when considering logical links 415, 425 shown as dashed line segments. Logical links exist between Device 1 and Device 2 415, between Device 2 and Device 3 425. Attacks by an attacker are performed in a network link 445, 446, 447, and characteristics such as cost depend on the network link. However, the consequences of the attack depend on the affected logical links 415, 425. Each network link can be associated with none, one or multiple logical links.

The result of the simulation is a sequence of actions that could be performed by the attacker to maximize the impact on the defined system KPI, constraining the effort to the defined budget.

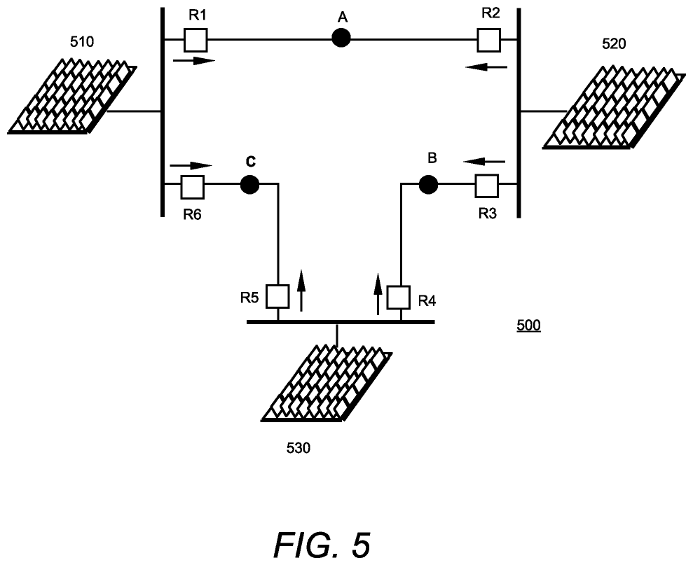

FIG. 5 proviides a more concrete example of the whole process according to one embodiment, a power system network includes 3 photovoltaic (PV) distributed energy resources (DERs) 510, 520 530 based on the IEEE 3 bus system. The system includes resistors R1-R6, and nodes A, B, C. It is assumed that a simulation model of the system is available, which may be based on tools such as OpenDSS.

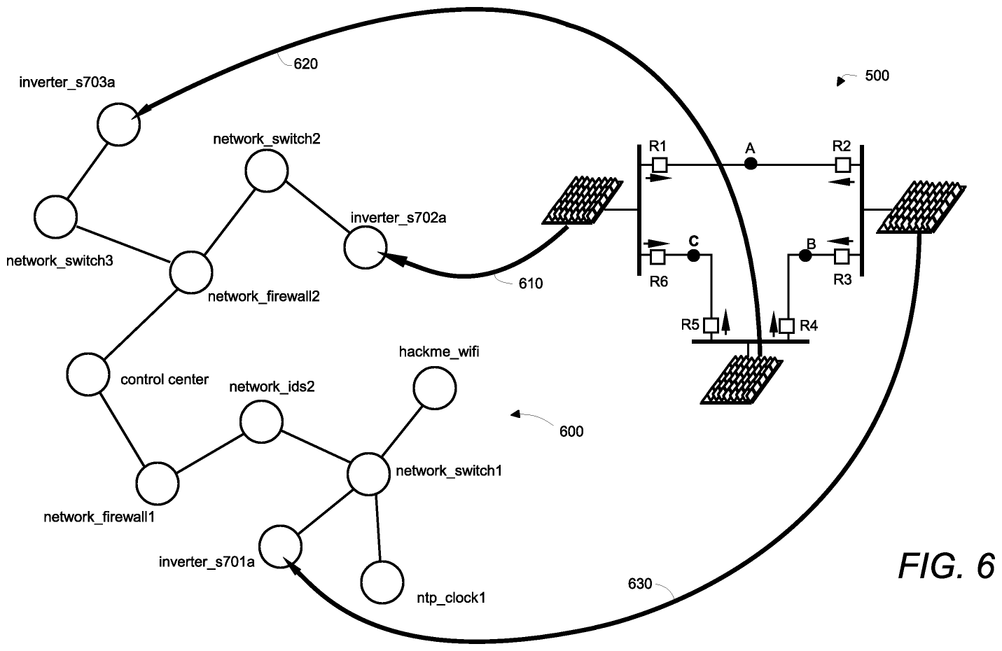

FIG. 6 illustrates the next step, the creation of the cyberattack information layer including the devices and network links, possible attacker actions, associated cost/time, and the encoding of this information in NetJSON format. FIG. 6 shows an example of computer network topology 600 and association to power system devices. As shown on the left side of FIG. 6, a visualization of the computer network topology 600 encoded in NetJSON is representative of the physical elements shown in the system 500 of FIG. 5. The arrows 610, 620, 630 indicate the correspondence between devices in the computer network 600 and in the power system 500. Once this information is available, optimization based on MCTS may be performed, based on a defined KPI, which may be evaluated by the power system model, such as Voltage Unbalance Factor (VUF) and constrained by the available attacker budget. The flowchart of FIG. 3 is employed during optimization to update the states of each device and network link from a cyberattack perspective.

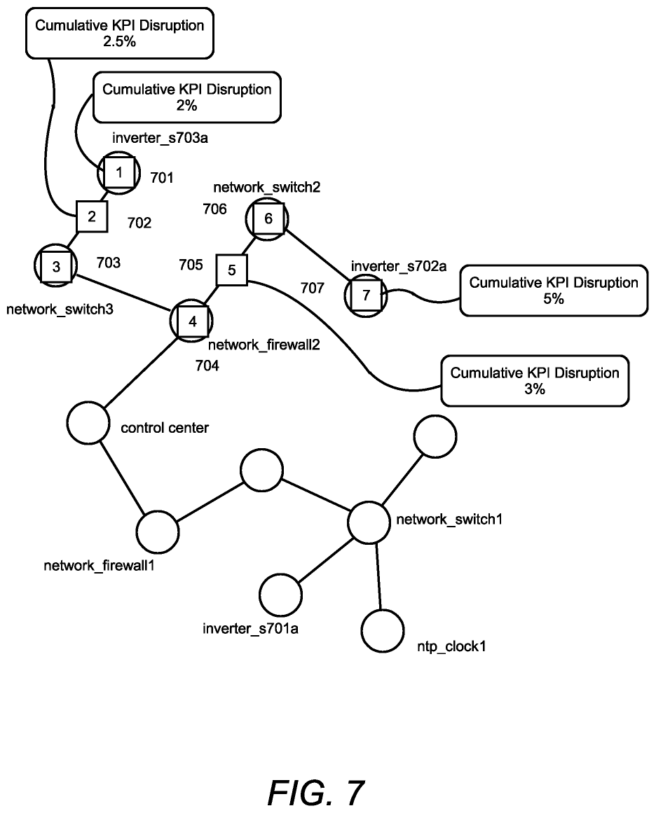

FIG. 7 is a visualization of a most impactful attack path affecting a KPI of interest according to an embodiment of this disclosure. An AI-based optimization evaluates action choices of an attacker from the nodes 600 FIG. 6 against KPIs of interest. The numbered nodes 701, 703, 704, 706, 707 and links 702, 705 indicate the order in which the network devices or links are accessed and exploited by the adversary as provided in the numbered squares 1-7. Examples of cumulative impact (%) on the KPI are shown for each step where the attacker performs an end-effect action. The outcome is an identification of the most critical vulnerabilities that re defined by the OT system KPIs and likelihood of exploitation. As an example, a KPI of interest can be voltage unbalance factor. In an embodiment, a follow-on analysis may consist of defining potential defensive strategies that limit the KPI disruption to 2%.

In summary, the disclosed embodiments provide a direct integration of the system functionality into the cybersecurity analysis, which is not present in any existing tools. This integration is beneficial when analyzing and addressing vulnerabilities that can disrupt system operation. It allows for much more preciselly estimating and quantifying the potential impacts of worst case cyberattacks in terms of standard operation KPIs that are well understood by system operators.

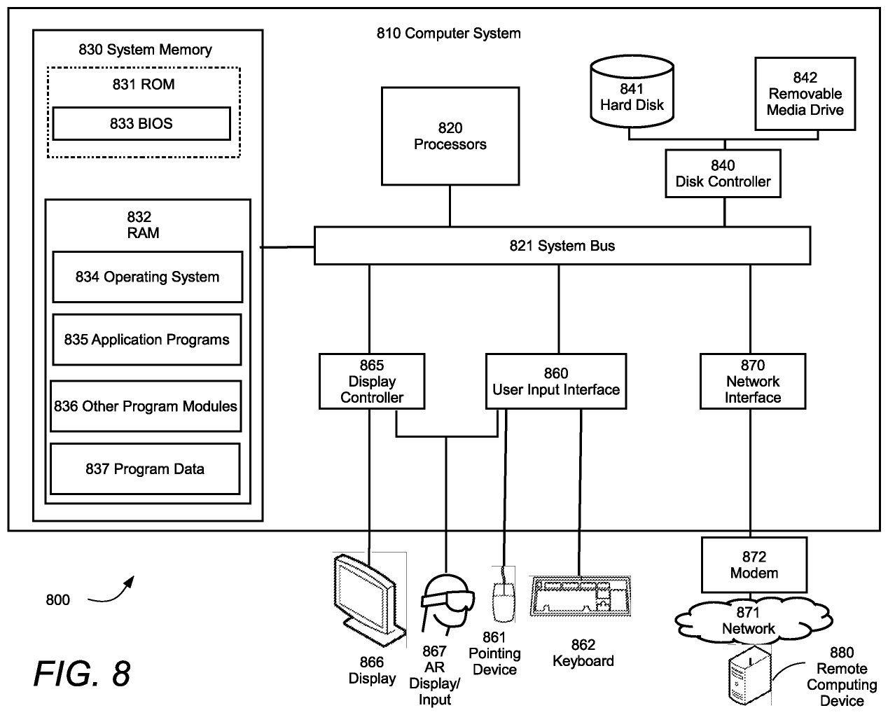

FIG. 8 illustrates an exemplary computing environment 800 within which embodiments of the invention may be implemented. Computers and computing environments, such as computer system 810 and computing environment 800, are known to those of skill in the art and thus are described briefly here.

As shown in FIG. 8, the computer system 810 may include a communication mechanism such as a system bus 821 or other communication mechanism for communicating information within the computer system 810. The computer system 810 further includes one or more processors 820 coupled with the system bus 821 for processing the information.

The processors 820 may include one or more central processing units (CPUs), graphical processing units (GPUs), or any other processor known in the art. More generally, a processor as used herein is a device for executing machine-readable instructions stored on a computer readable medium, for performing tasks and may comprise any one or combination of, hardware and firmware. A processor may also comprise memory storing machine-readable instructions executable for performing tasks. A processor acts upon information by manipulating, analyzing, modifying, converting or transmitting information for use by an executable procedure or an information device, and/or by routing the information to an output device. A processor may use or comprise the capabilities of a computer, controller or microprocessor, for example, and be conditioned using executable instructions to perform special purpose functions not performed by a general-purpose computer. A processor may be coupled (electrically and/or as comprising executable components) with any other processor enabling interaction and/or communication there-between. A user interface processor or generator is a known element comprising electronic circuitry or software or a combination of both for generating display images or portions thereof. A user interface comprises one or more display images enabling user interaction with a processor or other device.

Continuing with reference to FIG. 8, the computer system 810 also includes a system memory 930 coupled to the system bus 821 for storing information and instructions to be executed by processors 820. The system memory 830 may include computer readable storage media in the form of volatile and/or nonvolatile memory, such as read only memory (ROM) 831 and/or random-access memory (RAM) 832. The RAM 832 may include other dynamic storage device(s) (e.g., dynamic RAM, static RAM, and synchronous DRAM). The ROM 831 may include other static storage device(s) (e.g., programmable ROM, erasable PROM, and electrically erasable PROM). In addition, the system memory 830 may be used for storing temporary variables or other intermediate information during the execution of instructions by the processors 820. A basic input/output system 833 (BIOS) containing the basic routines that help to transfer information between elements within computer system 810, such as during start-up, may be stored in the ROM 831. RAM 832 may contain data and/or program modules that are immediately accessible to and/or presently being operated on by the processors 820. System memory 830 may additionally include, for example, operating system 834, application programs 935, other program modules 836 and program data 837.

The computer system 810 also includes a disk controller 840 coupled to the system bus 821 to control one or more storage devices for storing information and instructions, such as a magnetic hard disk 841 and a removable media drive 842 (e.g., floppy disk drive, compact disc drive, tape drive, and/or solid-state drive). Storage devices may be added to the computer system 810 using an appropriate device interface (e.g., a small computer system interface (SCSI), integrated device electronics (IDE), Universal Serial Bus (USB), or FireWire).

The computer system 810 may also include a display controller 865 coupled to the system bus 821 to control a display or monitor 866, such as a cathode ray tube (CRT) or liquid crystal display (LCD), for displaying information to a computer user. The computer system includes an input interface 860 and one or more input devices, such as a keyboard 862 and a pointing device 861, for interacting with a computer user and providing information to the processors 820. The pointing device 861, for example, may be a mouse, a light pen, a trackball, or a pointing stick for communicating direction information and command selections to the processors 820 and for controlling cursor movement on the display 866. The display 866 may provide a touch screen interface which allows input to supplement or replace the communication of direction information and command selections by the pointing device 861. In some embodiments, an augmented reality device 867 that is wearable by a user, may provide input/output functionality allowing a user to interact with both a physical and virtual world. The augmented reality device 867 is in communication with the display controller 865 and the user input interface 860 allowing a user to interact with virtual items generated in the augmented reality device 867 by the display controller 865. The user may also provide gestures that are detected by the augmented reality device 867 and transmitted to the user input interface 860 as input signals.

The computer system 810 may perform a portion or all of the processing steps of embodiments of the invention in response to the processors 820 executing one or more sequences of one or more instructions contained in a memory, such as the system memory 830. Such instructions may be read into the system memory 830 from another computer readable medium, such as a magnetic hard disk 841 or a removable media drive 842. The magnetic hard disk 841 may contain one or more datastores and data files used by embodiments of the present invention. Datastore contents and data files may be encrypted to improve security. The processors 820 may also be employed in a multi-processing arrangement to execute the one or more sequences of instructions contained in system memory 830. In alternative embodiments, hard-wired circuitry may be used in place of or in combination with software instructions. Thus, embodiments are not limited to any specific combination of hardware circuitry and software.

As stated above, the computer system 810 may include at least one computer readable medium or memory for holding instructions programmed according to embodiments of the invention and for containing data structures, tables, records, or other data described herein. The term “computer readable medium” as used herein refers to any medium that participates in providing instructions to the processors 820 for execution. A computer readable medium may take many forms including, but not limited to, non-transitory, non-volatile media, volatile media, and transmission media. Non-limiting examples of non-volatile media include optical disks, solid state drives, magnetic disks, and magneto-optical disks, such as magnetic hard disk 841 or removable media drive 842. Non-limiting examples of volatile media include dynamic memory, such as system memory 830. Non-limiting examples of transmission media include coaxial cables, copper wire, and fiber optics, including the wires that make up the system bus 821. Transmission media may also take the form of acoustic or light waves, such as those generated during radio wave and infrared data communications.

The computing environment 800 may further include the computer system 810 operating in a networked environment using logical connections to one or more remote computers, such as remote computing device 880. Remote computing device 880 may be a personal computer (laptop or desktop), a mobile device, a server, a router, a network PC, a peer device or other common network node, and typically includes many or all of the elements described above relative to computer system 810. When used in a networking environment, computer system 810 may include modem 872 for establishing communications over a network 871, such as the Internet. Modem 872 may be connected to system bus 821 via user network interface 870, or via another appropriate mechanism.

Network 871 may be any network or system generally known in the art, including the Internet, an intranet, a local area network (LAN), a wide area network (WAN), a metropolitan area network (MAN), a direct connection or series of connections, a cellular telephone network, or any other network or medium capable of facilitating communication between computer system 810 and other computers (e.g., remote computing device 980). The network 871 may be wired, wireless or a combination thereof. Wired connections may be implemented using Ethernet, Universal Serial Bus (USB), RJ-6, or any other wired connection generally known in the art. Wireless connections may be implemented using Wi-Fi, WiMAX, and Bluetooth, infrared, cellular networks, satellite or any other wireless connection methodology generally known in the art. Additionally, several networks may work alone or in communication with each other to facilitate communication in the network 871.

An executable application, as used herein, comprises code or machine-readable instructions for conditioning the processor to implement predetermined functions, such as those of an operating system, a context data acquisition system or other information processing system, for example, in response to user command or input. An executable procedure is a segment of code or machine-readable instruction, sub-routine, or other distinct section of code or portion of an executable application for performing one or more particular processes. These processes may include receiving input data and/or parameters, performing operations on received input data and/or performing functions in response to received input parameters, and providing resulting output data and/or parameters.

A graphical user interface (GUI), as used herein, comprises one or more display images, generated by a display processor and enabling user interaction with a processor or other device and associated data acquisition and processing functions. The GUI also includes an executable procedure or executable application. The executable procedure or executable application conditions the display processor to generate signals representing the GUI display images. These signals are supplied to a display device which displays the image for viewing by the user. The processor, under control of an executable procedure or executable application, manipulates the GUI display images in response to signals received from the input devices. In this way, the user may interact with the display image using the input devices, enabling user interaction with the processor or other device.

The functions and process steps herein may be performed automatically or wholly or partially in response to user command. An activity (including a step) performed automatically is performed in response to one or more executable instructions or device operation without user direct initiation of the activity.

The system and processes of the figures are not exclusive. Other systems, processes and menus may be derived in accordance with the principles of the invention to accomplish the same objectives. Although this invention has been described with reference to particular embodiments, it is to be understood that the embodiments and variations shown and described herein are for illustration purposes only. Modifications to the current design may be implemented by those skilled in the art, without departing from the scope of the invention. As described herein, the various systems, subsystems, agents, managers and processes can be implemented using hardware components, software components, and/or combinations thereof. No claim element herein is to be construed under the provisions of 35 U.S.C. 112, sixth paragraph, unless the element is expressly recited using the phrase “means for.”

What is claimed is:

1. A method for identifying and analyzing potential cybersecurity threats in an engineered system comprising:
storing information relating to cybersecurity in a cybersecurity information layer;
performing a functional simulation representative of the engineered system, based in part on the information stored in the cybersecurity information layer; and
performing a sequential decision-making optimization to identify a most impactful cyberattack vector with respect to a key performance indicator (KPI) of interest.

2. The method of claim 1, wherein the cybersecurity information layer comprises topology and device information corresponding to the engineered system, and information about potential cybersecurity attacks that may be performed affecting a device or communication link of the engineered system.

3. The method of claim 2, wherein the cybersecurity information layer further comprises information about measures of an associated effort required for implementation of each of the potential cybersecurity attacks affecting a device or communication link.

4. The method of claim 1, wherein the sequential decision making optimization is implemented using artificial intelligence (AI) based techniques.

5. The method of claim 3, wherein one of the communication links is a logical link between a first device and a second device.

6. The method of claim 3, wherein one of the communication links is a physical network link between a first device and a second device.

7. The method of claim 6, wherein the physical network link connects the first device and a router.

8. The method of claim 1, further comprising:
iteratively performing the sequential decision-making optimization to produce a sequence of attacker steps that generates a maximum disruption to operation of the engineered system.

9. The method of claim 8, further comprising:
measuring and optimizing the sequential decision-making optimization based on configurable key performance indicators (KPIs) associated with operation of the engineered system.

10. The method of claim 1, further comprising:
storing in the cybersecurity information layer, information about the engineered system's topology encoded as netJSON format.

11. The method of claim 10, wherein a device in the engineered system's topology adversary actions are encoded in layers including an exposure layer, an exploitability layer and an end-effect layer.

12. The method of claim 10, wherein a communication link in the engineered system's topology adversary actions are encoded in layers including an exposure layer and an end-effect layer.

13. The method of claim 1, further comprising:
considering during the AI-based sequential decision-making optimization, an associated effort required for each possible action taken by an attacker.

14. The method of claim 13, further comprising:
considering during the AI-based sequential decision-making optimization, an attacker profile representative of the skill level of an attacker.

15. The method of claim 1, wherein the AI-based sequential decision-making optimization is performed using a Monte Carlo Tree Search.

16. A computer-based system for analyzing cybersecurity threats in an engineered system comprising:
a computer processor in communication with a non-transitory memory, the non-transitory memory storing computer instructions, that when executed by the computer processor, cause the computer processor to:
perform a functional simulation of the engineered system;
store cyberattack information and perform the functional simulation of the engineered system in part on the cybersecurity threat information; and
perform an artificial intelligence (AI) based sequential decision-making optimization to identify a sequence of attacker actions.

17. The system of claim 16, further comprising computer instructions stored in the non-transitory memory that when executed by the computer processor cause the computer processor to:
identify the sequence of attacker actions that represent a most impactful attack on the engineered system based on a key performance indicator (KPI) of interest.

18. The system of claim 16, wherein the cyberattack information includes information relating to a topology and devices in the engineered system from a computer network perspective.

19. The system of claim 16, wherein the AI-based sequential decision-making optimization is performed using a Monte Carlo Tree Search.

20. The system of claim 16, further comprising computer instructions stored in the non-transitory memory that when executed by the computer processor cause the computer processor to:
for each possible attack affecting a device or communication link of the engineered system, computing a measure of associated effort required to carry out each possible attack.
